(19) United States
(12) Patent Application Publication
(10) Pub. No.: US 2011/0192929 A1
(43) Pub. Date: Aug. 11, 2011

(54) REEL AND RECORDING TAPE CARTRIDGE

(75) Inventor: Kazuo HIRAGUCHI, Kanagawa (JP)

(73) Assignee: FUJIFILM CORPORATION, Tokyo (JP)

(21) Appl. No.: 13/019,312

(22) Filed: Feb. 2, 2011

(30) Foreign Application Priority Data
Feb. 5, 2010 (JP) 2010-024753

(51) Int. Cl. G11B 23/107; B65H 75/14; B65H 75/18

(52) U.S. Cl. 242/348; 242/608

(57) ABSTRACT

A reel hub, that is made of resin, of a reel has a cylindrical tube portion around whose outer peripheral surface a recording tape is wound, a floor portion that juts-out inwardly in a radial direction from one end portion in an axial direction of the cylindrical tube portion, and a reel plate that is made of metal and is fixed to the floor portion coaxially. A thin-walled portion, whose thickness is thinner than a radial direction thickness of the cylindrical tube portion, is formed continuously or intermittently over an entire periphery between an inner peripheral surface of the cylindrical tube portion and an outer peripheral surface of the reel plate in a radial direction of the floor portion.

### CROSS-REFERENCE TO RELATED APPLICATION

This application claims priority under 35 USC 119 from Japanese Patent Application No. 2010-024753, filed on Feb. 5, 2010, the disclosure of which is incorporated by reference herein.

### BACKGROUND OF THE INVENTION

1. Field of the Invention

The present invention relates to a reel around which a recording tape such as a magnetic tape or the like is wound, and to a recording tape cartridge that houses, in a case, a reel around which a magnetic tape is wound.

2. Description of the Related Art

Reels are known that are formed by flanges, that are formed of a resin material having an elastic modulus that is equivalent to or greater than that of the resin material of a hub that is formed of resin, being welded to the end portions of the hub (see, for example, Japanese Patent Application Laid-Open (JP-A) No. 2003-7030). Further, a technique is known of improving the circularity of the outer peripheral surface of a hub by forming plural groove portions, that are formed at uniform intervals in the peripheral direction between a reel gear formed at the floor portion of the hub that is shaped as a cylindrical tube having a floor and a reel plate that is fixed to this floor portion, such that the groove portions have portions whose peripheral direction positions coincide with gate marks (see, for example, JP-A No. 2009-64506).

The above-described techniques are techniques that suppress deformation of the hub due to the pressure of winding of the tape, and improve the circularity before the tape is wound. However, it is desired to make the shape of the hub after deformation be a good shape.

### SUMMARY OF THE INVENTION

An object of the present invention is to provide a reel and a recording tape cartridge in which the outer peripheral surface of a hub forms a proper shape in a state in which a recording tape is wound therearound.

A reel relating to a first aspect of the present invention has: a hub that is made of resin and has a cylindrical tube portion, around whose outer peripheral surface a recording tape is wound, and an overhanging portion, that juts-out inwardly in a radial direction from one end portion side in an axial direction of the cylindrical tube portion; and a plate that is made of metal, and that forms a disc shape or an annular shape that is coaxial with the hub, and that is fixed to the overhanging portion, wherein a thin-walled portion, that is made to be thinner than a radial direction thickness at one end portion side of the cylindrical tube portion, is formed continuously or intermittently over an entire periphery at a portion between an inner peripheral surface of the hub and an outer peripheral surface of the plate in a radial direction of the overhanging portion.

In the reel relating to the first aspect of the present invention, the thin-walled portion, that is thinner-walled than the cylindrical tube portion, is formed in the outer peripheral side portion of the overhanging portion at the hub. Therefore, when the winding pressure of the recording tape acts on the cylindrical tube portion in the radial direction, the hub bendingly-deforms at the thin-walled portion that is set at the outer side of the plate that is made of metal. Due thereto, at one end portion side of the cylindrical tube portion, that is the side at which the overhanging portion is formed, the effect of restraining deformation toward the radial direction inner side by the overhanging portion is kept small. As compared with a structure in which the thin-walled portion is not provided, the difference, in the radial direction deformation that is caused by the tape winding pressure, between the one end portion side and the axial direction other end that is the open end side of the cylindrical tube portion, is small.

In this way, in the reel relating to the first aspect of the present invention, the outer peripheral surface of the hub forms a proper shape in the state in which the recording tape is wound therearound.

In the reel relating to the first aspect of the present invention, a groove, at which the outer peripheral surface of the plate is at least a portion of a groove wall, may be formed continuously or intermittently over the entire periphery by the overhanging portion and the plate, and the thin-walled portion may be formed such that one end in a thickness direction of the thin-walled portion is a groove floor or a grove wall of the groove at the overhanging portion.

In the reel of the above-described structure, the outer peripheral surface of the plate is exposed as a groove wall. Therefore, interference of the plate with the above-described deformation, whose starting point is the thin-walled portion of the overhanging portion, is suppressed, which contributes to the outer peripheral surface of the hub forming a proper shape in the state in which the recording tape is wound therearound.

In the reel of the above-described structure, the thin-walled portion may be structured such that a depth of the groove is set to be larger than a thickness of the plate.

In the reel of the above-described structure, because the groove is deeper than the thickness of the plate, it is easy for the above-described deformation, whose starting point is the thin-walled portion at the overhanging portion of the hub, to arise, which contributes to the outer peripheral surface of the hub forming a proper shape in the state in which the recording tape is wound therearound.

In the reel relating to the first aspect of the present invention, the thin-walled portion may be formed so as to be thinnest in a direction along an axial direction of the hub.

In the reel of the above-described structure, due to the winding pressure of the recording tape toward the hub, the thin-walled portion deforms so as to bend in the axial direction of the hub. The effect of restraining radially-inward deformation at one axial direction end portion side of the cylindrical tube portion is thereby kept small.

In the reel relating to the first aspect of the present invention, the thin-walled portion may be formed so as to be thinnest in a direction along a radial direction of the hub.

In the reel of the above-described structure, due to the winding pressure of the recording tape toward the hub, the thin-walled portion deforms so as to bend in the radial direction of the hub. The effect of restraining radially-inward deformation at one axial direction end portion side of the cylindrical tube portion is thereby kept small.

In the reel of the above-described structure, a reinforcing member, that is structured of a material having a higher elastic modulus than a material structuring the hub and that reinforces the cylindrical tube portion in a radial direction, may be provided at another end portion in the axial direction at the cylindrical tube portion.

In the reel of the above-described structure, the open end side of the cylindrical tube portion, at which the rigidity in the radial direction is relatively low, is reinforced in the radial direction by the reinforcing member. Therefore, deformation, caused by the winding pressure of the tape, at this open end side is suppressed. Thus, the difference in radial direction deformation, that is caused by the winding pressure of the tape, at the both axial direction ends of the hub is kept even smaller.

A recording tape cartridge relating to a second aspect of the present invention has: the single reel relating to the first aspect of the present invention at which the recording tape is wound around an outer periphery of the hub; and a case that accommodates the reel such that the reel is rotatable.

In the recording tape cartridge of the above-described structure, because the hub, around which the recording tape is wound, forms a proper shape, bending in the transverse direction of the recording tape is suppressed. Due thereto, the traveling of the recording tape is stable.

As described above, the reel and recording tape cartridge relating to the present invention have the excellent effect that the outer peripheral surface of a hub forms a proper shape in a state in which a recording tape is wound therearound.

### BRIEF DESCRIPTION OF THE DRAWINGS

FIG. 1 is a cross-sectional view showing, in an enlarged manner, main portions of a reel relating to a first exemplary embodiment of the present invention;

FIG. 2 is an exploded perspective view of the reel relating to the first exemplary embodiment of the present invention;

FIG. 3 is a bottom view of the reel relating to the first exemplary embodiment of the present invention;

FIG. 4 is a perspective view showing, in an enlarged manner, a plate holding portion of the reel relating to the first exemplary embodiment of the present invention;

FIG. 5A and FIG. 5B are drawings showing a simulation model of the reel relating to the first exemplary embodiment of the present invention, where FIG. 5A is a side sectional view before deformation and FIG. 5B is a side sectional view after deformation;

FIG. 6 is a diagram showing the shape, after winding of a tape, of the outer peripheral surface of a reel hub that structures the reel relating to the first exemplary embodiment of the present invention;

FIG. 7 is a side sectional view at a time of non-use of a recording tape cartridge relating to the first exemplary embodiment of the present invention;

FIG. 8 is a side sectional view at a time of use of the recording tape cartridge relating to the first exemplary embodiment of the present invention;

FIGS. 9A and 9B are drawings showing the recording tape cartridge relating to the first exemplary embodiment of the present invention, where FIG. 9A is a perspective view seen from above and FIG. 9B is a perspective view seen from below;

FIG. 10 is an exploded perspective view of reel locking structural portions of the recording tape cartridge relating to the first exemplary embodiment of the present invention;

FIG. 11 is a bottom view of a reel relating to a second exemplary embodiment of the present invention;

FIG. 12 is a cross-sectional view showing, in an enlarged manner, main portions of a reel relating to a third exemplary embodiment of the present invention;

FIG. 13 is a cross-sectional view showing, in an enlarged manner, main portions of a reel relating to a fourth exemplary embodiment of the present invention;

FIG. 14 is a cross-sectional view showing, in an enlarged manner, main portions of a reel relating to a fifth exemplary embodiment of the present invention; and

FIG. 15 is a cross-sectional view showing, in an enlarged manner, main portions of a reel relating to a sixth exemplary embodiment of the present invention.

### DETAILED DESCRIPTION OF THE INVENTION

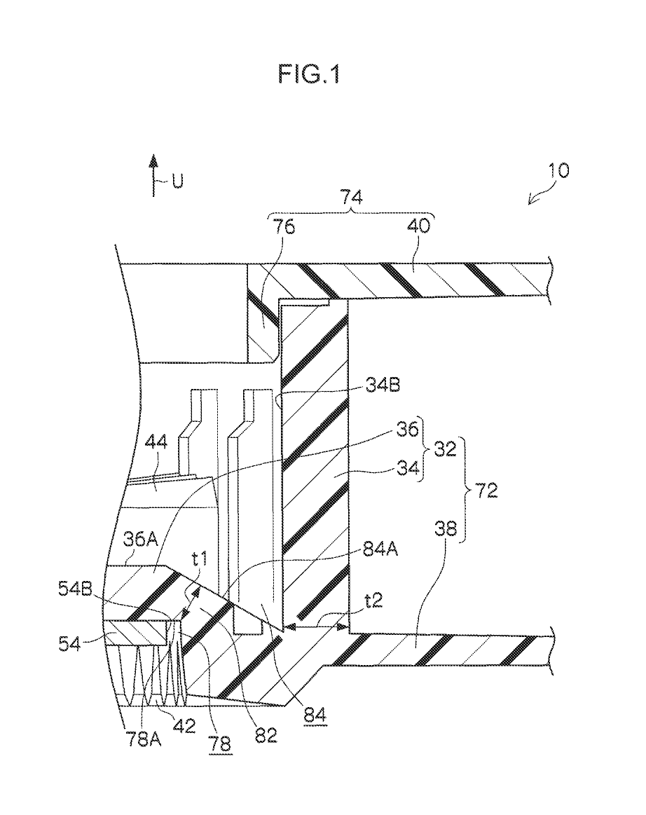

A reel 10 relating to a first exemplary embodiment of the present invention, and a recording tape cartridge 11 that is structured to include the reel 10, are described on the basis of FIG. 1 through FIG. 10. First, the schematic overall structure of the recording tape cartridge 11 including the reel 10 is described, and then, the characteristic structure of the reel 10 is described. Note that, for convenience of explanation, the direction of loading the recording tape cartridge 11 into a drive device is denoted by arrow A, and this is the forward direction (front side) of the recording tape cartridge 11. Further, the direction indicated by arrow U is the upward direction (the upper side) of the recording tape cartridge 11.

(Schematic Overall Structure of Recording Tape Cartridge)

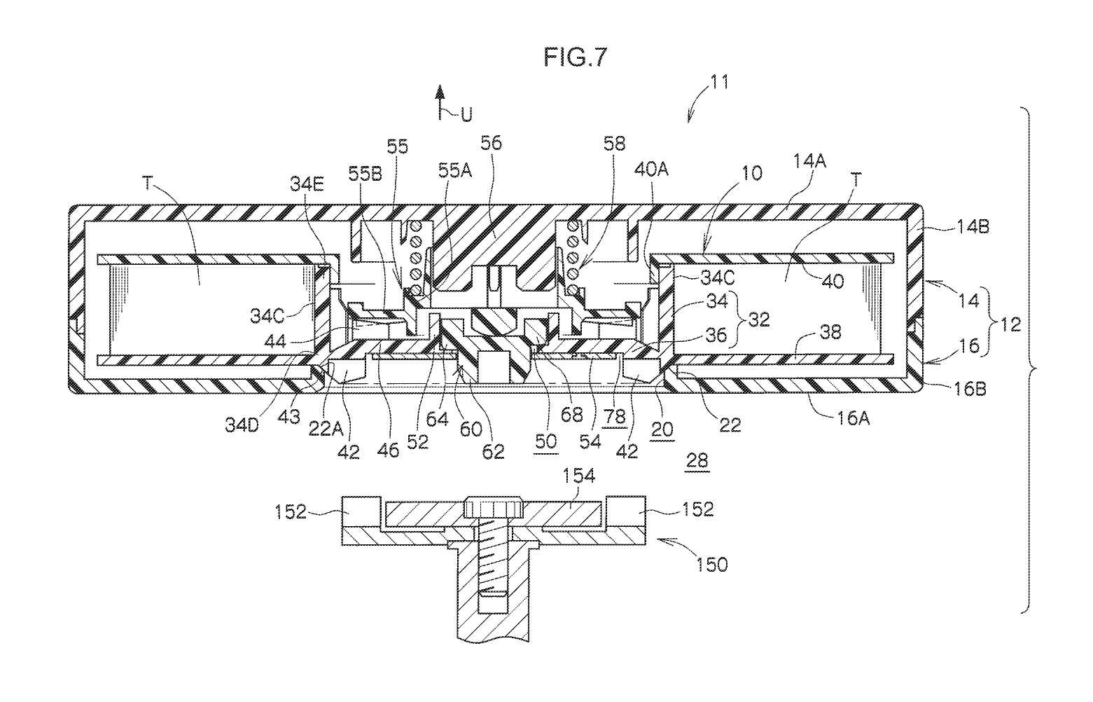

As shown in FIG. 7 through FIG. 9B, the recording tape cartridge 11 relating to the present exemplary embodiment has a case 12. The case 12 is structured by an upper case 14 and a lower case 16 being joined together. Specifically, the upper case 14 is structured such that a substantially frame-shaped peripheral wall 14B stands erect along the outer edge of a ceiling plate 14A that is substantially rectangular in plan view. The lower case 16 is structured such that a peripheral wall 16B stands erect along the outer edge of a floor plate 16A that has a configuration substantially corresponding to that of the ceiling plate 14A. The case 12 is formed substantially in the shape of a box by the upper case 14 and the lower case 16 being joined together by ultrasonic welding or screws or the like in a state in that the open end of the peripheral wall 14B and the open end of the peripheral wall 16B abut one another.

At a corner portion of the case 12 at the leading side in the direction of loading the recording tape cartridge 11 into a drive device, the ceiling plate 14A, the peripheral wall 14B, the floor plate 16A, and the peripheral wall 16B are respectively cut-out such that an opening 18, that is inclined with respect to the direction of loading, is formed. Further, a circular gear opening 20 that passes through the floor plate 16A is provided in the substantially central portion of the floor plate 16A, and is for exposing a reel gear 42 that will be described below. At the edge portion of the gear opening 20 at the floor plate 16A, an annular rib 22 projects toward the interior of the case 12, and is for positioning and dust-proofing the reel 10 that will be described below.

As shown in FIG. 7, only one of the reel 10 is rotatably accommodated in the case 12. A magnetic tape T serving as a recording tape is wound on the reel 10. A leader block 30 serving as a leader member is attached to the distal end of the magnetic tape T. When the recording tape cartridge 11 is not being used, the leader block 30 is accommodated and held at the inner side of the opening 18 of the case 12. In this state, the leader block 30 closes-off the opening 18 and impedes entry of dust and the like into the case 12.

When the magnetic tape T is to be pulled-out within the drive device, the leader block 30 is pulled-out from the case 12 by a pull-out means of the drive device, and is guided to a take-up reel (not shown) of the drive device. Note that, instead of the leader block, a leader pin that is shaped as a small shaft or a leader tape that is tape-shaped may be employed as the leader member. In this case, for example, a door member for opening and closing the opening 18 is provided at the case 12. Further, the opening 18 may be formed along the peripheral walls 14B, 16B (by cutting-out only the peripheral walls 14B, 16B).

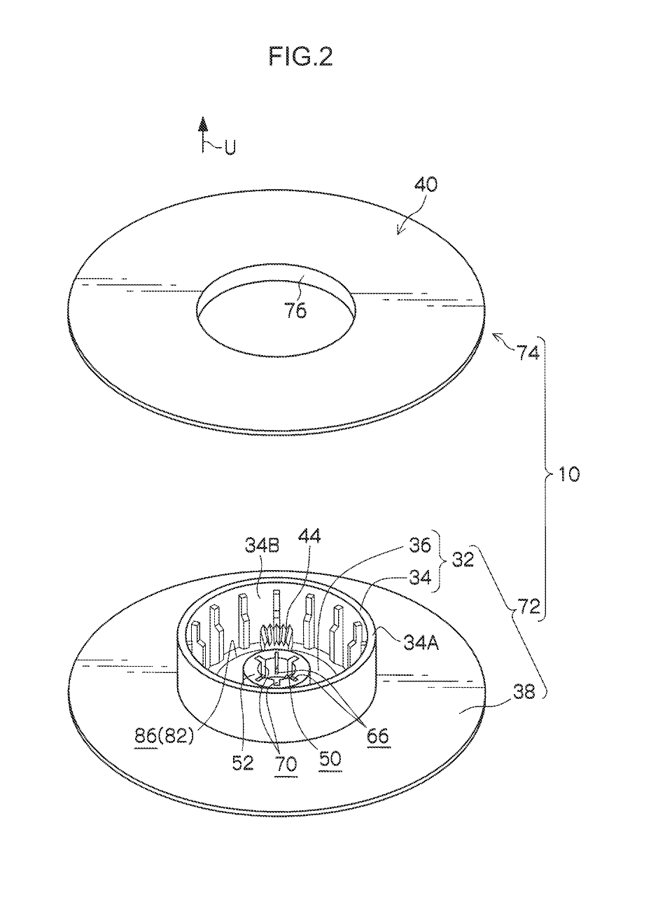

As shown in FIG. 2 through FIG. 4, the reel 10 has a reel hub 32 that structures the axially central portion thereof. The reel hub 32 is formed substantially in the shape of a cylindrical tube having a floor, and has a cylindrical tube portion 34 around whose outer peripheral surface the magnetic tape T is wound, and a floor portion 36 that closes the bottom portion of the cylindrical tube portion 34. The floor portion 36 can be interpreted as an overhanging portion that juts-out inwardly in the radial direction from the lower end portion of the cylindrical tube portion 34.

A lower flange 38, that juts outwardly in the radial direction of the reel hub 32, is provided in a vicinity of the floor portion 36 side end portion (the lower end portion) of the reel hub 32. On the other hand, an upper flange 40, that juts outwardly in the radial direction of the reel hub 32, is provided at the upper end portion of the cylindrical tube portion 34. At the reel 10, the magnetic tape T is wound around the outer peripheral surface of the cylindrical tube portion 34 of the reel hub 32, between the opposing surfaces of the lower flange 38 and the upper flange 40.

The reel gear 42, that is annular and formed coaxially with the reel 10, is formed to project in a vicinity of the outer periphery of the bottom surface (the outer surface) of the floor portion 36 of the reel hub 32. The reel gear 42 can mesh together with a driving gear 152 that is provided at the distal end of a rotating shaft 150 of the drive device. On the other hand, as shown in FIG. 2 through FIG. 4, plural engaging gears 44, that are formed along a circumference that is coaxial with the reel 10, are provided in a vicinity of the outer periphery of the top surface (the inner surface) of the floor portion 36 of the reel hub 32. The engaging gears 44 can mesh together with a braking gear portion 55B of a braking member 55 that is described below.

A pass-through hole 50 is provided in the axially central portion of the floor portion 36 of the reel hub 32. A boss portion 52 for a clutch stands erect along the edge portion of the pass-through hole 50, from the top surface of the floor portion 36. The boss portion 52 for a clutch is described together with a clutch member 60 that is described below.

Although details thereof are described below, the main portions of the reel 10 are formed by resin molding. The reel has a reel plate 54 that is annular and serves as a plate that is fixed to the inner side of the reel gear 42 at the bottom surface (the surface) of the floor portion 36 of the reel hub 32. The reel plate 54 is formed in a toroidal shape of a metal, magnetic material, and is fixed coaxially to the floor portion 36 of the reel hub 32. The annular reel plate 54 is attracted to and held by a magnet 154 of the rotating shaft 150 of the drive device.

The above-described reel 10 is accommodated within the case 12, and, when the recording tape cartridge 11 is not in use, the reel 10 is placed on the annular rib 22. Concretely, radial direction displacement of the reel 10 is restrained due to the outer side portion of a taper portion 43, that is continuous with the radial direction outer side of the reel gear 42 at the floor portion 36, (i.e., a vicinity of the inner edge of the lower flange 38) abutting the top end surface of the annular rib 22, and the inner edge portion of the top end of the annular rib 22 being made to be a taper surface 22A that corresponds to the taper portion 43.

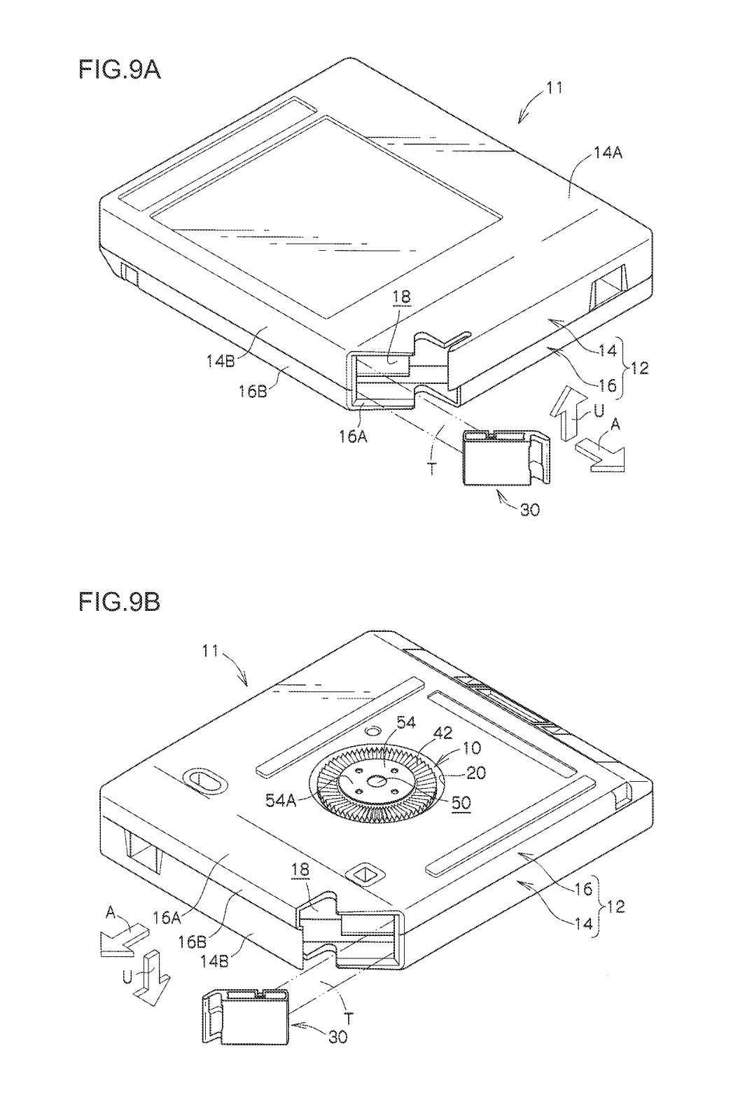

In this state, the reel 10 overall is positioned within the case 12, and the reel gear 42 and the reel plate 54 are exposed from the gear opening 20 (see FIG. 9B). Namely, the reel gear 42 does not project-out from the outer surface (the bottom surface) of the floor plate 16A, and looks out onto the exterior of the case 12 from the gear opening 20. Further, the pass-through hole 50 looks out onto the gear opening 20 through a through-hole 54A that is formed in the axial center of the reel plate 54. Due thereto, operation of the reel 10, i.e., chucking (holding) and driving/rotating, are possible from the exterior of the case 12.

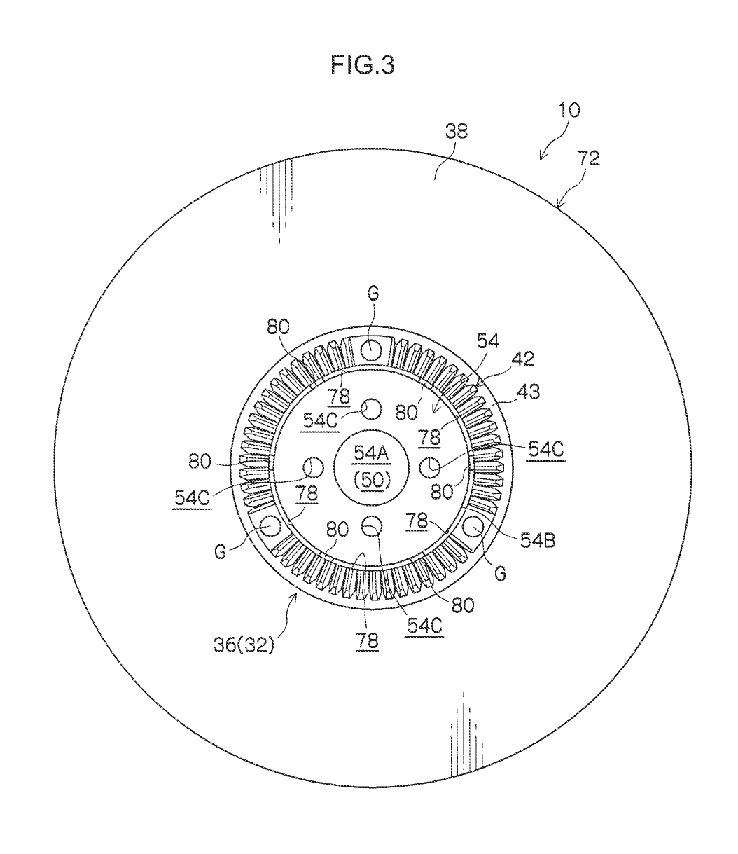

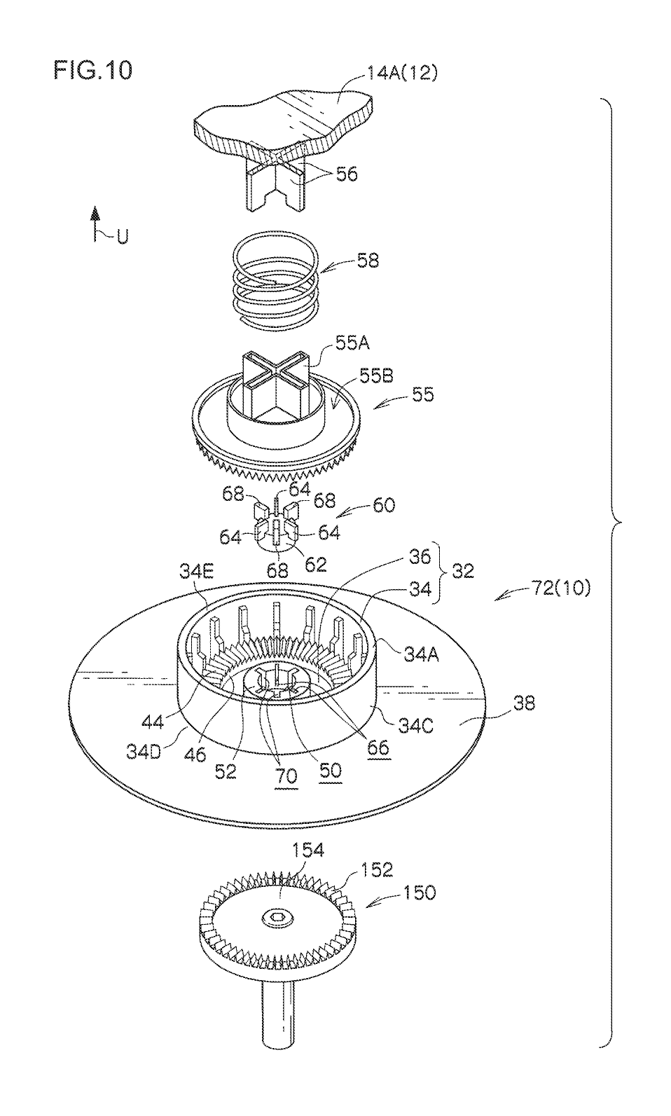

Further, as shown in FIG. 3, FIG. 7 and FIG. 10, the recording tape cartridge 11 has the braking member 55 that is for impeding rotation of the reel 10 at times of non-use. The braking member 55 is structured such that a rotation restraining portion 55A and the braking gear portion 55B are the main portions thereof. A cross-shaped rib 56, that projects-out from the ceiling plate 14A of the case 12, is inserted into the rotation restraining portion 55A such that relative rotation with respect to the case 12 is restrained. The braking gear portion 55B extends outwardly in the radial direction from the bottom end of the rotation restraining portion 55A, and can engage with the engaging gears 44 of the reel 10.

Due to the braking member 55 being displaced in the axial direction of the reel 10 within the case 12 at times of non-use, the braking member 55 can selectively be placed at a braking position, at which the braking gear portion 55B meshes-together with the engaging gears 44, and a rotation permitting position, at which the meshing-together of the braking gear portion 55B and the engaging gears 44 is cancelled. A compression coil spring 58 is disposed in a compressed state between the ceiling plate 14A of the case 12 and the braking member 55. The braking member 55 is offset toward the braking position due to the urging force of the compression coil spring 58.

The recording tape cartridge 11 has the clutch member 60 that is operated from the exterior when the locked state of the reel 10 by the braking member 55 is to be cancelled. When the driving gear 152 of the rotating shaft 150 of the drive devices meshes-together with the reel gear 42, the clutch member 60 is pushed by the rotating shaft 150 and displaces the braking member 55 upward, i.e., toward the rotation permitting position.

Concretely, the clutch member 60 is disposed between the floor portion 36 of the reel 10 and the braking member 55, and has a clutch main body 62 that passes-through the floor portion 36. Plural guide ribs 64 and plural stopper ribs 68 extend outwardly in the radial direction from the clutch main body 62. Due to the guide ribs 64 being placed in rotation restraining grooves 66 that are formed in the boss portion 52 for a clutch of the reel 10, the guide ribs 64 have the function of restraining relative rotation of the clutch member 60 with respect to the reel 10, and a guiding function of guiding the clutch member 60 in the axial direction of the reel 10. Due to the stopper ribs 68 abutting stopper surfaces 70A of stopper grooves 70 that are formed in the boss portion 52 for a clutch, the stopper ribs 68 have the function of positioning the clutch member 60 in the axial direction with respect to the reel 10 (including the function of preventing the clutch member 60 from being pulled-out).

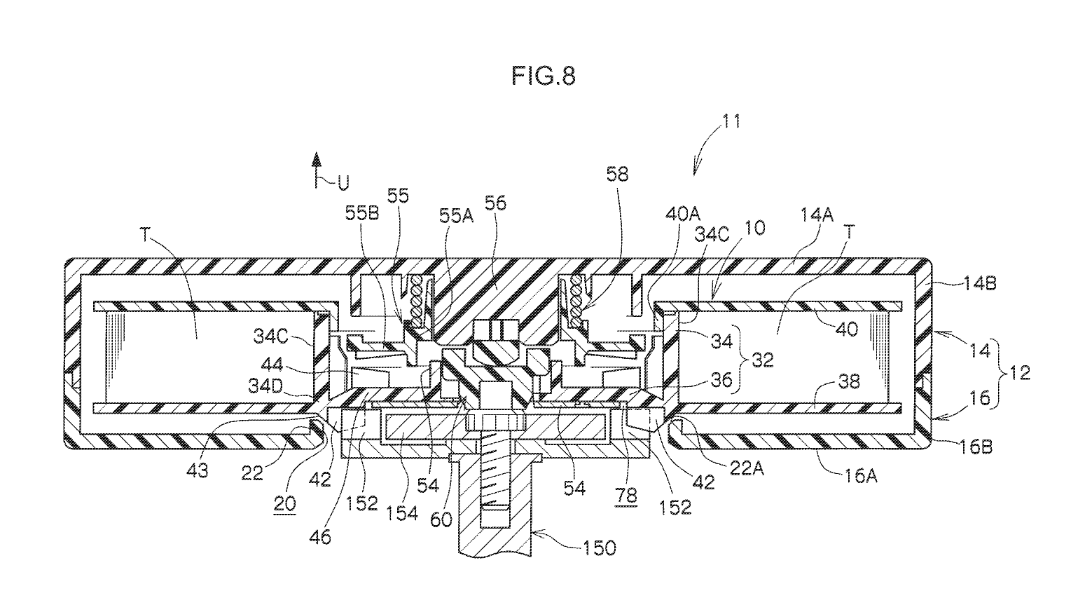

As described above, in the recording tape cartridge 11, at times of non-use, the braking member 55 causes the braking gear portion 55B to mesh-together with the reel gear 42 due to the urging force of the compression coil spring 58 as shown in FIG. 7, such that rotation of the reel 10 with respect to the case 12 is prevented. On the other hand, as shown in FIG. 8, when the reel gear 42 of the reel 10 is meshed-together with the driving gear 152 of the rotating shaft 150 of the drive device, the clutch member 60 that is pushed by the rotating shaft 150 displaces the braking member 55 to the rotation permitting position, and rotation of the reel 10 with respect to the case 12 is thereby permitted.

(Detailed Structure of Reel)

As shown in FIG. 2, the reel 10 relating to the present exemplary embodiment is a two-piece structure of a lower flange attached hub member 72 at which the reel hub 32 and the lower flange 38 are formed integrally, and an upper flange member 74 serving as a flange member whose main portion is the upper flange 40. At the lower flange attached hub member 72, the reel hub 32 and the lower flange 38 are formed integrally by injection molding of a resin. Further, the lower flange attached hub member 72 in the present exemplary embodiment is a structure in which the reel plate 54, that is made of metal, is insert molded.

The upper flange member 74 is structured such that an annular rib 76, that is fit-together with the inner periphery of the cylindrical tube portion 34 of the reel hub 32, projects-out from the inner edge portion of the upper flange 40 that forms a toroidal shape. In the state in which the annular rib 76 is fit-together with the cylindrical tube portion 34 of the reel hub 32, the portion of the upper flange member 74, which portion is at the radial direction outer side of the annular rib 76 (i.e., the portion between the upper flange 40 and the annular rib 76), is fixed by ultrasonic welding or the like to a top end surface 34A of the cylindrical tube portion 34.

At the reel plate 54, plural (four in the present exemplary embodiment, as shown in FIG. 3), stepped holes 54C, at which the hole diameter of the lower side thereof is greater than that at the upper side thereof, are provided at uniform intervals in the peripheral direction. The reel plate 54 is held at the lower flange attached hub member 72 at resin that is placed in the stepped holes 54C and at plate holding portions 80 that are described below.

As shown in FIG. 3, groove portions 78, that serve as the grooves in the present invention and that expose an outer peripheral surface 54B (thickness portion) of the reel plate 54, are formed between the reel plate 54 and the reel gear 42 at the floor portion 36 of the reel hub 32 (the lower flange attached hub member 72). In other words, the outer peripheral surface 54B of the reel plate 54 forms one widthwise direction groove wall of each of the groove portions 78. Further, in the present exemplary embodiment, the thickness of the reel plate 54 prescribes the depth of the groove portions 78.

A plurality (greater than or equal to four, and six in the present exemplary embodiment) of the groove portions 78 in the present exemplary embodiment are provided at uniform intervals in the peripheral direction of the reel hub 32. These groove portions 78 are formed as holding portion (positioning portion) marks of the reel plate 54 by a mold at the time of insert molding the reel plate 54 to the lower flange attached hub member 72.

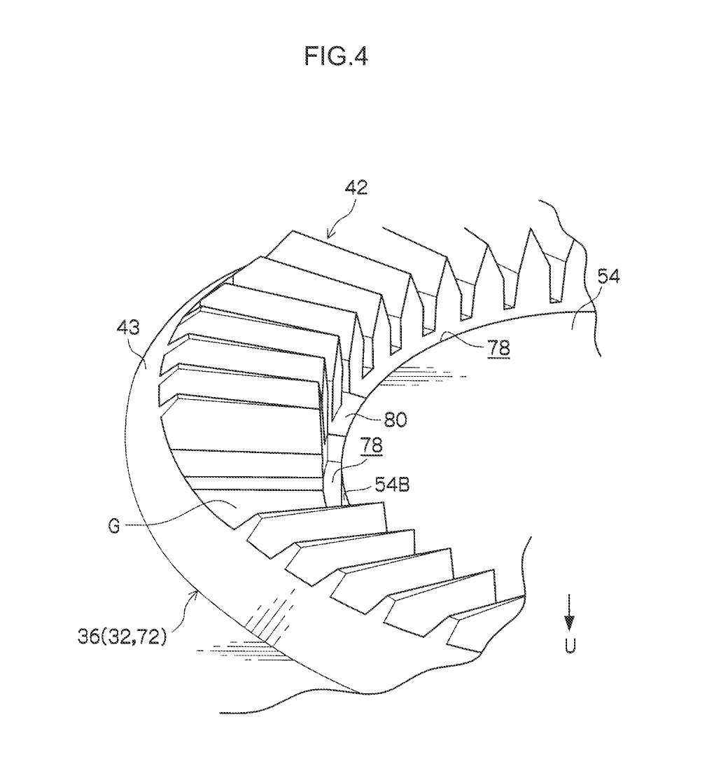

Further, in the reel 10, the plate holding portions (non-groove portions) 80, that cover the outer peripheral surface 54B of the reel plate 54 from the radial direction outer side while contacting the outer peripheral surface 54B as shown in FIG. 4, are formed between these six groove portions 78. Accordingly, in the present exemplary embodiment, as shown in FIG. 3, six of the plate holding portions 80 are disposed at uniform intervals in the peripheral direction at the periphery of the reel plate 54. Further, as shown in FIG. 3, in the present exemplary embodiment, the plate holding portions 80 are disposed so as to be offset, in the peripheral direction, with respect to three gate marks G that are marks for gates at the time of forming the lower flange attached hub member 72 by injection molding of a resin. Note that, in the present exemplary embodiment, the gate marks G are formed at discontinuous portions, in the peripheral direction, of the reel gear 42.

Here, in the present exemplary embodiment, the groove width of the groove portion 78 (the radial direction gap between the reel plate 54 and the reel gear 42) is approximately 0.6 [mm], and the groove depth is approximately 0.8 [mm]. Further, in the present exemplary embodiment, the diameter of the reel plate 54 is approximately 30 [mm] (the peripheral length of the reel plate 54 is approximately 94 [mm]), and the peripheral direction length of each plate holding portion 80 is approximately 2.5 [mm]. Accordingly, it can be understood that the peripheral direction length of the plate holding portion 80 is sufficiently short as compared with the peripheral direction length of the groove portion 78 (approximately 13.2 [mm]). The depth of the groove portions 78 in the present exemplary embodiment coincides with the thickness of the reel plate 54.

As shown in FIG. 1, a thin-walled portion 82, whose thickness t1 is thinner than radial direction thickness t2 of the cylindrical tube portion 34, is formed at the floor portion 36 of the reel hub 32 at the portion between an inner peripheral surface 34B of the cylindrical tube portion 34 and the outer peripheral surface 54B of the reel plate 54 as seen in the axial direction. The thin-walled portion 82 is formed continuously over the entire circumference, due to an annular recess 84 being formed at the outermost peripheral portion of a top surface 36A of the floor portion 36. The annular recess 84 in the present exemplary embodiment is a shape that gradually becomes deeper toward the inner peripheral surface 34B of the cylindrical tube portion 34.

The thickness t1 of the thin-walled portion 82 is set as the minimum thickness from a floor surface 84A of the annular recess 84 to a floor surface 78A of the groove portion 78. Namely, one end in the thickness direction of the thin-walled portion 82 is the floor surface 78A of the groove portion 78. On the other hand, the thickness t2 in the radial direction of the cylindrical tube portion 34 is set as the thickness at the lower end portion of the cylindrical tube portion 34. In the present exemplary embodiment, as an example, t2=2.5 mm and t1=1.4 mm.

The above-described lower flange attached hub member 72 (the reel hub 32) is formed by injection molding of a fiber-reinforced plastic in which glass fibers serving as the reinforcing fibers are mixed-in in an amount of substantially 10% by mass into polycarbonate that serves as a thermoplastic resin. The fiber-reinforced plastic, in which glass fibers are mixed-in in an amount of substantially 10% by mass, has a bending elastic modulus of approximately 3400 [mPa] and a linear expansion coefficient of approximately 5 to 6 [10⁻⁵/K] (approximately 5[10⁻⁵/K] in the direction substantially parallel to the fiber orientation direction and approximately 6[10⁻⁵/K] in the direction substantially orthogonal to the fiber orientation direction).

On the other hand, the upper flange member 74 that structures the reel 10 is structured by a fiber-reinforced plastic in which glass fibers are mixed-in in an amount of substantially 30% by mass into polycarbonate, i.e., a material whose elastic modulus is higher than that of the material structuring the lower flange attached hub member 72. Concretely, the fiber-reinforced plastic, in which glass fibers are mixed-in in an amount of substantially 30% by mass, has a bending elastic modulus of approximately 6600 [mPa] and a linear expansion coefficient of approximately 3 to 6 [10⁻⁵/K] (approximately 3 [10⁻⁵/K] in the direction substantially parallel to the fiber orientation direction and approximately 6[10⁻⁵/K] in the direction substantially orthogonal to the fiber orientation direction).

The upper flange member 74, that is structured of a material having a higher elastic modulus than that of the material structuring the lower flange attached hub member 72 and that is fixed to the top end surface 34A of the cylindrical tube portion 34, corresponds to the reinforcing member in the present invention. Namely, the upper flange member 74 functions to reinforce, in the radial direction, the upper end portion at the cylindrical tube portion 34 of the reel hub 32.

Operation of the first exemplary embodiment is described next.

At the recording tape cartridge 11 of the above-described structure, as shown in FIG. 7, at times of non-use, due to the urging force of the compression coil spring 58, the braking member 55 is positioned at the rotation locking position and causes the braking gear portion 55B to mesh-together with the engaging gears 44. Therefore, rotation of the reel 10 with respect to the case 12 is impeded. At this time, the reel gear 42 of the reel 10 is exposed from the gear opening 20, and the clutch main body 62 of the clutch member 60 is inserted-through the pass-through hole 50 and looks-out onto the gear opening 20.

On the other hand, when the magnetic tape T is to be used, the recording tape cartridge 11 is loaded into a bucket (not shown) of the drive device along the direction of arrow A. Then, when the recording tape cartridge 11 is loaded to a predetermined depth in the bucket, the bucket is lowered, and the rotating shaft 150 of the drive device relatively approaches the gear opening 20 of the case 12 (relatively moves upward), and holds the reel 10. Concretely, the driving gear 152 of the rotating shaft 150 meshes-together with the reel gear 42 while the reel plate 54 is attracted to and held by the magnet 154 in a non-contact state.

Accompanying the meshing-together of the reel gear 42 and the driving gear 152, i.e., the relative movement of the rotating shaft 150 in the direction of approaching the case 12 along the axial direction, the axially central portion of the rotating shaft 150 abuts the clutch main body 62 of the clutch member 60, and pushes the clutch member 60 upward against the urging force of the compression coil spring 58. Due thereto, the brake member 55, that is abutting the clutch member 60, also moves upward, and the meshing-together of the engaging gears 44 and the braking gear portion 55B of the braking member 55 is cancelled.

Namely, the braking member 55 arrives at the rotation permitting position relative to the reel 10. When the rotating shaft 150 moves further upward, the reel 10 is brought upward together with the clutch member 60 and the braking member 55 (with their relative positions remaining unchanged) against the urging force of the compression coil spring 58. Due thereto, at the recording tape cartridge 11, the braking member 55 reaches the absolute rotation permitting position (with respect to the case 12), and the lower flange 38 moves away from the annular rib 22. Due to the above operations, as shown in FIG. 8, the reel 10 rises-up within the case 12, and becomes able to rotate in a state of not contacting the inner surfaces of the case 12. Further, although detailed description thereof is omitted, due to the bucket, i.e., the recording tape cartridge 11, being lowered within the drive device, the recording tape cartridge 11 is positioned in the horizontal direction and in the vertical direction with respect to the drive device.

Then, while a pull-out pin (not illustrated) of the pull-out means of the drive device engages with the leader block 30, the pull-out means takes the leader block 30 out from the case 12 and guides the leader block 30 to the take-up reel of the drive device. Further, the leader block 30 is fit into the take-up reel and forms a portion of the take-up surface around which the magnetic tape T is taken-up. In this state, when the leader block 30 rotates integrally with the take-up reel, the magnetic tape T is pulled-out from the case 12 through the opening 18, while being taken-up onto the reel hub of the take-up reel.

At this time, the reel 10 of the recording tape cartridge 11 rotates synchronously with the take-up reel due to the rotational force of the rotating shaft 150 that is transmitted by the driving gear 152 that is meshed-together with the reel gear 42. Then, recording of information onto the magnetic tape T, or playback of information recorded on the magnetic tape T, is carried out by a recording/playback head that is disposed along a predetermined tape path of the drive device. At this time, the braking member 55, that cannot rotate with respect to the case 12, slidingly-contacts the clutch member 60 that rotates together with the reel 10 with respect to the case 12.

On the other hand, when the magnetic tape T is rewound onto the reel 10 and the leader block 30 is held in a vicinity of the opening 18 of the case 12, the bucket in which the recording tape cartridge 11 is loaded rises. Thus, the meshing-together of the reel gear 42 and the driving gear 152 is cancelled, the abutment of the rotating shaft 150 and the clutch member 60 is cancelled, and the clutch member 60 moves downward together with the braking member 55 (with the state of abutment thereof maintained) due to the urging force of the compression coil spring 58.

In this way, the respective stopper ribs 68 of the clutch member 60 abut the stopper surfaces 70A, and the braking gear portion 55B of the braking member 55 meshes-together with the engaging gears 44. Namely, the braking member 55 returns to the rotation locking position at which the braking member 55 impedes rotation of the reel 10 with respect to the case 12. Further, accompanying the operation of the braking member 55 and the clutch member 60 moving due to the urging force of the compression coil spring 58, the reel 10 also moves downward. While the lower flange 38 of the reel 10 is made to abut the annular rib 22, the reel gear 42 is returned to its initial state of being exposed from the gear opening 20. In this state, the recording tape cartridge 11 is ejected from the bucket.

At the reel 10 that structures the recording tape cartridge 11, when the magnetic tape T is wound around the reel hub 32, the winding pressure of the magnetic tape T acts on the cylindrical tube portion 34, and the cylindrical tube portion 34 is deformed in the radial direction. It is easy for the radially-inward deformation of the cylindrical tube portion 34 to becomes large in a vicinity of the central portion in the axial direction that can be interpreted as being a region between the supporting portions of supporting beams at both ends as seen in the cross-section shown in FIG. 1. Further, at the upper end (upper flange 40) side and the lower end (floor portion 36) side of the cylindrical tube portion 34, it is easy for the radially-inward deformation of the cylindrical tube portion 34 to become larger at the upper end side that is the opening end side than at the lower end side that is the side closed by the floor portion 36. Namely, a difference in the radial direction deformation arises at the upper and lower ends of the cylindrical tube portion 34. In particular, in a case in which the magnetic tape T that is thin-walled (e.g., 6.6 μm) is wound to a predetermined wound diameter, it is easier for the difference in deformation at the upper and lower sides of the cylindrical tube portion 34 to become large than in a case in which the relatively thick-walled (short) magnetic tape T is wound to a predetermined wound diameter.

Here, at the reel 10, the groove portions 78 are formed in the floor portion 36 at the radial direction outer side of the reel plate 54. Therefore, as compared with a hub that is structured such that groove portions corresponding to the groove portion 78 are not formed in the floor portion, it is easy for the lower end side of the cylindrical tube portion 34 to be deformed inwardly in the radial direction by the winding pressure of the magnetic tape T. Further, at the reel 10, the thin-walled portion 82 is formed at the portion of the floor portion 36 between the reel plate 54 and the cylindrical tube portion 34 as seen in the axial direction. Therefore, it is even easier for the lower end side of the cylindrical tube portion 34 to be deformed inwardly in the radial direction due to the winding pressure of the magnetic tape T. Moreover, because the thickness t1 of the thin-walled portion 82 is thinner than the thickness t2 of the lower end portion of the cylindrical tube portion 34, at the reel hub 32, it is easier for bending deformation (described in detail below) at the thin-walled portion 82 to arise than collapsing deformation toward the radial direction inner side of the cylindrical tube portion 34.

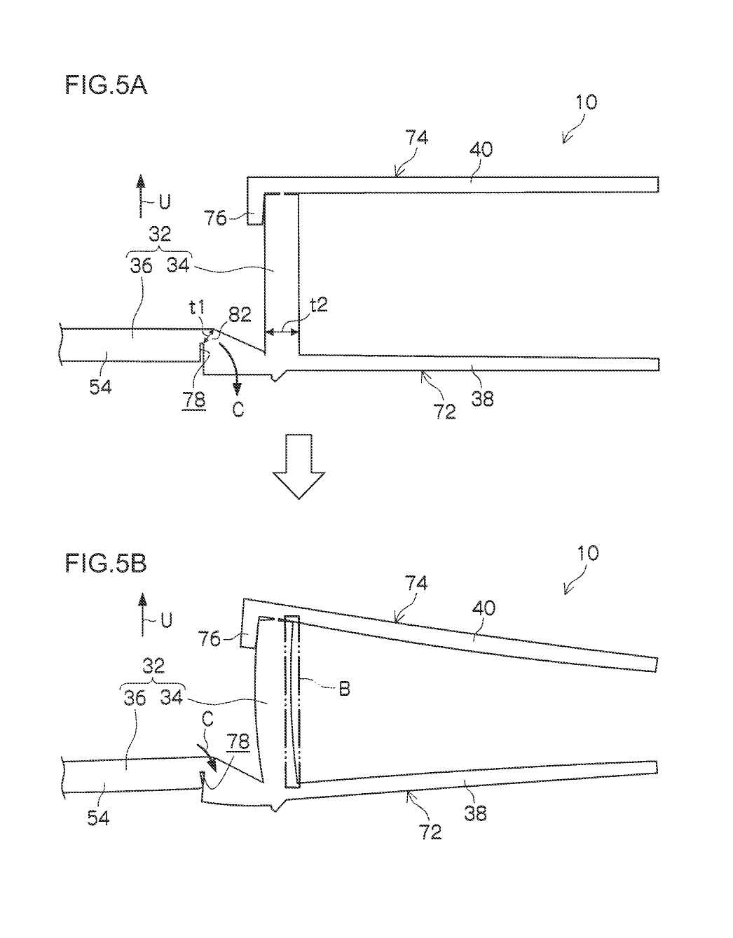

These points are described further with reference to the models shown in FIG. 5A and FIG. 5B (in which the deformation of the respective portions is illustrated in an exaggerated manner). FIG. 5A shows an analytical model of the reel 10 in a state in which winding pressure of the magnetic tape T is not applied, and FIG. 5B shows an analytical model of the reel 10 in a state in which winding pressure of the magnetic tape T is applied (results of simulation). From a comparison of these drawings, it can be understood that the floor portion 36 of the reel hub 32 is deformed (refer to arrow C) as if rotating toward the lower side with the thin-walled portion 82 being the starting point, and compressing the groove portions 78 in the widthwise (radial) direction. Namely, the floor portion 36 is bendingly deformed in the direction of arrow C, with the thin-walled portion 82 being the starting point, at the outer side of the range at which the reel plate 54 is positioned, which range is reinforced with respect to bending at the reel plate 54.

Due to the deformation of the floor portion 36, the cylindrical tube portion 34 is displaced toward the axial direction lower side and the radial direction inner side as if moving parallel, while collapsing deformation toward the radial direction inner side, whose starting point is the lower end of the cylindrical tube portion 34 (the root portion connected to the floor portion 36), is suppressed. Due thereto, at the reel 10, because the lower end side of the cylindrical tube portion 34 is relatively easily deformed (displaced) inwardly in the radial direction, the difference in radial direction deformation at the upper and lower sides of the cylindrical tube portion 34 can be kept small. Further, due to the winding pressure of the magnetic tape T, the cylindrical tube portion 34 is displaced as if moving parallel as described above. In other words, collapsing deformation of the cylindrical tube portion 34 is suppressed. Therefore, the upper end side of the cylindrical tube portion 34 being deformed (displaced) in the radial direction more greatly than the lower end side thereof also is suppressed.

Moreover, at the reel 10, the upper end side of the cylindrical tube portion 34 is reinforced by the upper flange member 74 that is structured by a material whose elastic modulus is higher than that of the material that structures the lower flange attached hub member 72. Therefore, radially-inward deformation of the upper end side of the cylindrical tube portion 34 due to the winding pressure of the magnetic tape T is suppressed as compared with a comparative example in which, for example, the upper flange member 74 is structured of a material having a lower elastic modulus than the material structuring the lower flange attached hub member 72.

Accordingly, at the reel 10, because it is relatively even more difficult for the upper end side of the cylindrical tube portion 34 to be deformed (displaced) inwardly in the radial direction, the difference in radial direction deformation of the cylindrical tube portion 34 at the upper and lower sides thereof is kept small for this reason as well. Namely, at the reel 10, the opening end portion, that has relatively low rigidity at the reel hub 32, is reinforced by the upper flange member 74, and, at the floor portion 36 side portion that has relatively high rigidity, deformation is promoted (the rigidity of this region is lowered) at the groove portions 78 and the thin-walled portion 82. Therefore, in the state in which the magnetic tape T is wound, the cylindrical tube portion 34 is deformed in manner that is well-balanced in the vertical direction (i.e., at the respective portions in the axial direction). Namely, at the present reel 10, the shape of the reel hub 32 after the tape T is wound is good.

Due to the above, at the reel 10 relating to the first exemplary embodiment, the outer peripheral surface of the reel hub 32 forms a proper shape in the state in which the magnetic tape T is wound therearound.

This point is described further while comparing

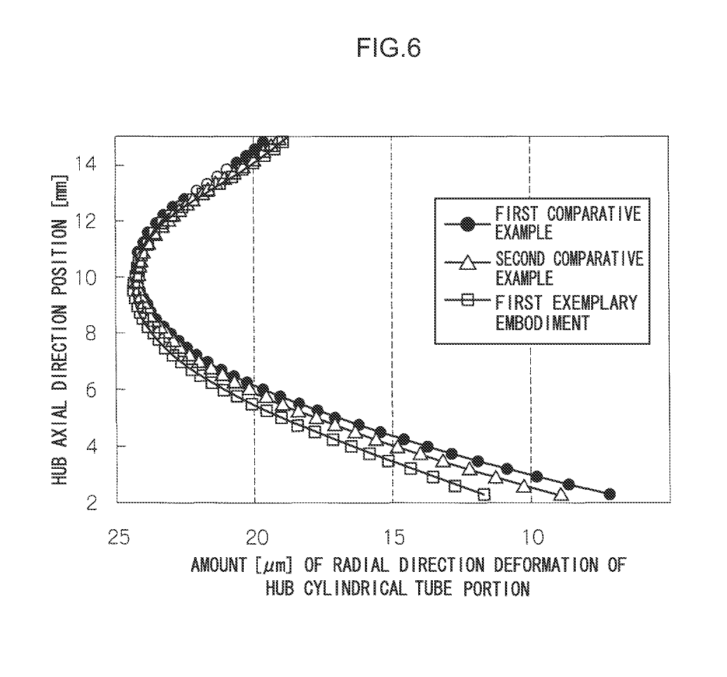

a first comparative example in which t1=2.6 mm (>t2), a second comparative example in which t1=1.9 mm, and the present exemplary embodiment, as shown in FIG. 6 that is results of simulation using the analytical model of FIG. 5A, in order to confirm the wound posture of the magnetic tape T. The black circles plotted in FIG. 6 show the first comparative example, the plotted white triangles show the second comparative example that is included in the present invention, and the plotted white squares show the shape of the hub after the tape is wound on the reel (the deformation amount per radius that is obtained by averaging, in the peripheral direction, the outer peripheral surface of the cylindrical tube portion 34 (portion B surrounded by the imaginary line in FIG. 5B) that is the surface around which the magnetic tape T is wound).

From FIG. 6, it can be understood that, in the first comparative example in which the thin-walled portion 82 is not formed, the effect of promoting radially-inward deformation of the floor portion 36 side of the reel hub 32 is small, and the difference in deformation at the upper and lower sides of the cylindrical tube portion 34 is great (approximately 12 μm). On the other hand, it can be understood that, in the second comparative example, because the thin-walled portion 82 is formed, the difference (approximately 10 μm) in deformation at the upper and lower sides of the cylindrical tube portion 34 is reduced as compared with the first comparative example. Further, in the reel 10 relating to the present exemplary embodiment, it can be understood that, because the thickness t2 of the thin-walled portion 82 is thin as compared with in the second comparative example, the difference (approximately 7 μm) in deformation at the upper and lower sides of the cylindrical tube portion 34 is reduced even more.

In this way, in the reel 10 relating to the present exemplary embodiment and the recording tape cartridge 11 that is equipped with the reel 10, the difference in deformation at the upper and lower sides of the reel hub 32 is small, and, as described above, the shape of the reel hub 32 in the state in which the tape T is wound therearound is good. Therefore, deformation of the magnetic tape T that is wound on the reel 10 is prevented or effectively suppressed.

Further, at the reel 10, the six, which is greater than or equal to four, plate holding portions 80 (groove portions 78) are provided in the peripheral direction. Therefore, the circularity, in plan view, of the cylindrical tube portion 34 of the reel hub 32 is good. In a comparative example in which, for example, the plate holding portions 80 are provided at only three places at uniform intervals in the peripheral direction, it is easy for the cylindrical tube portion 34 to become a substantially triangular shape whose vertices are the plate holding portions 80, due to the imbalance in shrinkage at the time of injection molding the lower flange attached hub member 72. At the reel hub 32 at which the cylindrical tube portion 34 has become substantially triangular in this way, it is easy for the winding pressure of the magnetic tape T to concentrate at the three vertices, i.e., the regions where the plate holding portions 80 are formed, and the above-described effect of promoting deformation of the lower end of the cylindrical tube portion 34 by the groove portions 78 is small. In contrast, in the reel 10, by providing four or more (six) of the plate holding portions 80, the circularity of the cylindrical tube portion 34 improves as compared with the aforementioned comparative example, and the distribution of the winding pressure of the magnetic tape T is made to be uniform in the peripheral direction of the cylindrical tube portion 34. Therefore, as described above, the deformation promoting effect due to the groove portions 78 is obtained.

### Other Exemplary Embodiments

Other exemplary embodiments of the present invention are described next. Note that parts and portions that are basically the same as structures of the first exemplary embodiment or structures that have been described hereinbefore are denoted by the same reference numerals as the first exemplary embodiment or the previously-described structures, and description thereof is omitted.

### Second Exemplary Embodiment

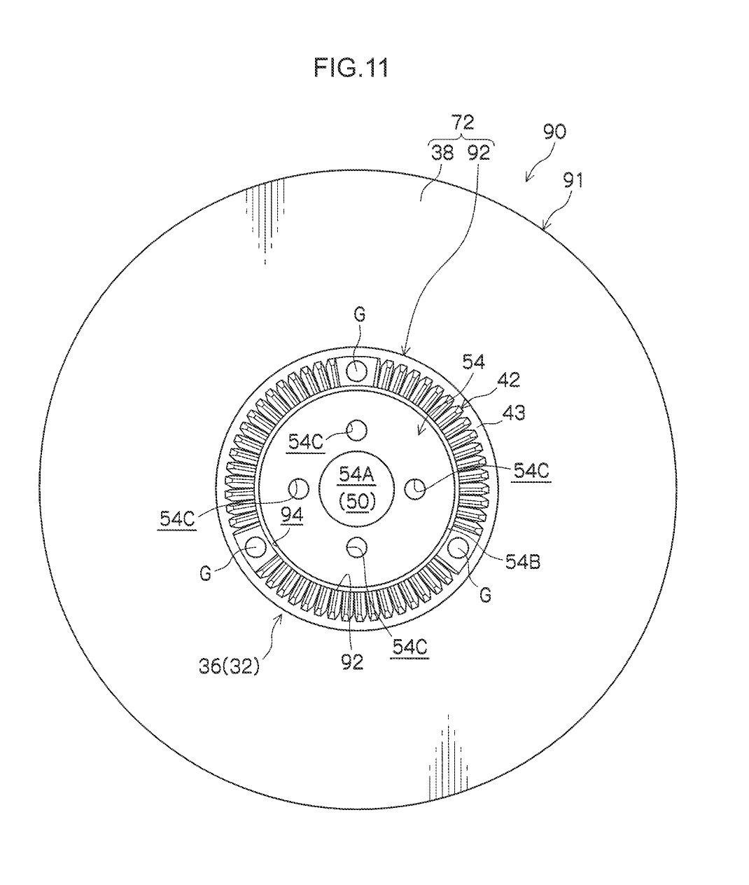

The lower flange attached hub member 72, that is provided with a reel hub 92 that structures a reel 90 relating to a second exemplary embodiment of the present invention, is shown in FIG. 11 in a bottom view that corresponds to FIG. 3. As shown in FIG. 11, the reel hub 92 differs from the reel hub 32 that structures the reel 10 relating to the first exemplary embodiment with regard to the point that the reel hub 92 does not have the plate holding portions 80 that cover (restrict) the outer peripheral surface 54B of the reel plate 54 from the radial direction outer side.

In the present exemplary embodiment, the portion of the floor portion 36 of the reel hub 92, which portion is at the outer peripheral side of the reel plate 54, is a groove portion 94 that serves as the groove in the present invention and that is continuous over the entire periphery. Namely, the groove portion 94 is structured such that the outer peripheral surface 54B of the reel plate 54 is the radial direction inner side groove wall of the groove portion 94, and the groove portion 94 exposes this outer peripheral surface 54B over the entire periphery. Therefore, the reel 90 is structured so as to not have portions that restrict the reel plate 54 from the radial direction such as the plate holding portions 80. The other structures of the reel 90 are the same as the corresponding structures of the reel 10 including the portions that are not illustrated.

Accordingly, the reel 90 relating to the second exemplary embodiment as well can achieve similar effects due to structures that are basically similar to those of the reel 10 relating to the first exemplary embodiment. Further, because the reel 90 does not have the plate holding portions 80, the load transmission path, by which the winding pressure of the magnetic tape T is supported at the reel plate 54 via the plate holding portions 80, does not exist. Therefore, even when compared with the reel 10, at the reel 90, it is easy for the floor portion 36 of the reel hub 32 to be deformed in the direction of arrow C with the thin-walled portion 82 being the starting point. Due thereto, at the reel 90, the difference in radial direction deformation at the upper and lower sides of the cylindrical tube portion 34 can be kept even smaller. Further, the circularity of the cylindrical tube portion 34 also is improved.

### Third Exemplary Embodiment

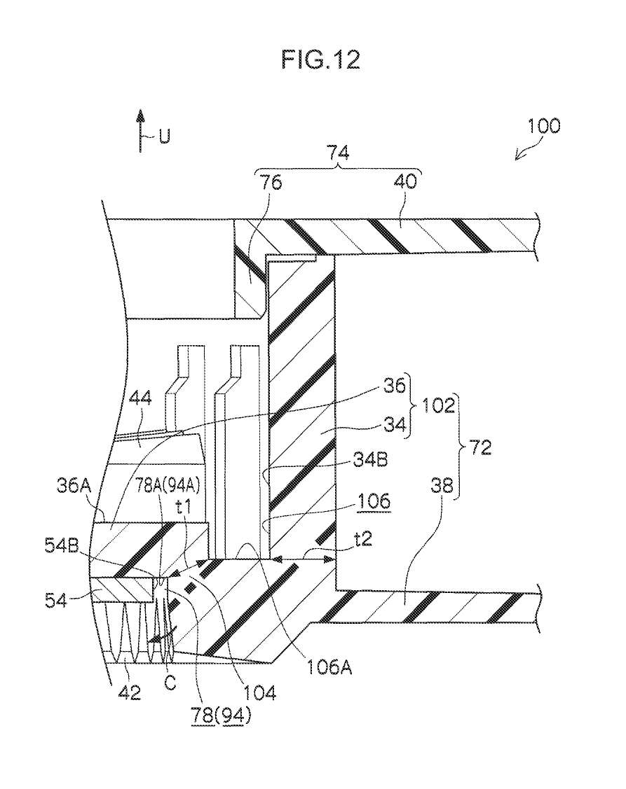

A reel 100 relating to a third exemplary embodiment of the present invention is shown in FIG. 12 in a side sectional view corresponding to FIG. 1. As shown in FIG. 12, the reel 100 differs from the reels 10, 90 of the first and second exemplary embodiments with regard to the point that a reel hub 102 that structures the reel 100 has a thin-walled portion 104 instead of the thin-walled portion 82.

The thin-walled portion 104 at the reel hub 102 is formed continuously over the entire periphery due to an annular recess 106, whose depth is substantially uniform in the radial direction, being formed in the outer peripheral portion of the top surface 36A of the floor portion 36. The thickness t1 of the thin-walled portion 104 in the present exemplary embodiment is set to be the minimum thickness from the inner peripheral edge portion at a floor surface 106A of the annular recess 106 to the outer peripheral edge portion at the floor surface 78A, 94A of the groove portion 78, 94.

Namely, one end in the thickness direction of the thin-walled portion 102 is the floor surface 78A, 94A of the groove portion 78, 94. The thin-walled portion 104 in the present exemplary embodiment is formed by forming the groove portion 78, 94 and the annular recess 106 to be offset in the axial direction of the reel 100. The other structures of the reel 100 are the same as the corresponding structures of the reel 10, including the portions that are not illustrated.

Accordingly, the reel 100 relating to the third exemplary embodiment as well can achieve similar effects due to structures that are basically similar to those of the reels 10, 90 relating to the first and second exemplary embodiments.

### Fourth Exemplary Embodiment

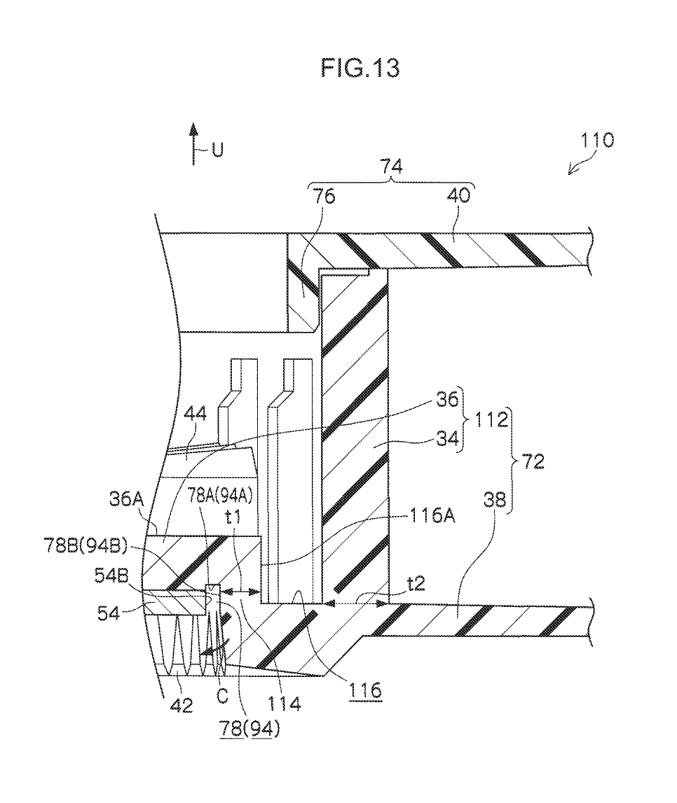

A reel 110 relating to a fourth exemplary embodiment of the present invention is shown in FIG. 13 in a side sectional view corresponding to FIG. 1. As shown in FIG. 13, the reel 110 differs from the reels 10, 90 of the first and second exemplary embodiments with regard to the point that a reel hub 112 that structures the reel 110 has a thin-walled portion 114 instead of the thin-walled portion 82.

The thin-walled portion 114 at the reel hub 112 is formed continuously over the entire periphery due to an annular recess 116, that overlaps the groove portion 78, 94 in the axial direction of the reel 110, being formed in the top surface 36A of the floor portion 36 at the radial direction outer side portion of the groove portion 78, 94. The thickness t1 of the thin-walled portion 114 in the present exemplary embodiment is set to be the minimum thickness from a groove wall 116A at the radial direction inner side of the annular recess 116 to a groove wall 78B, 94B at the radial direction outer side of the groove portion 78, 94.

Namely, one end in the thickness direction of the thin-walled portion 114 is the groove wall 78B, 94B of the groove portion 78, 94. The thin-walled portion 114 in the present exemplary embodiment is formed so as to be thinnest in the direction along the radial direction of the reel hub 32. Further, in the present exemplary embodiment, the depth of the groove portion 78, 94 is larger than the thickness of the reel plate 54, and the thin-walled portion 114, that is thin in the radial direction, has the required length in the axial direction. The bending direction (the direction of arrow C) of the thin-walled portion 114 due to the winding pressure of the magnetic tape T in this case is substantially inwardly in the radial direction. The other structures of the reel 110 are the same as the corresponding structures of the reel 10, including the portions that are not illustrated.

Accordingly, the reel 110 relating to the fourth exemplary embodiment as well can achieve similar effects due to structures that are basically similar to those of the reels 10, 90 relating to the first and second exemplary embodiments. Further, at the reel 110, although the flow path of the resin at the time of injection molding the lower flange attached hub member 72 is narrow due to the annular recess 116 being formed, no thick-walled portion is formed at the periphery (the upper side) of the reel gear 42, and therefore, sink marks that accompany resin shrinkage of the reel gear 42 are suppressed. Thus, at the reel 110, the accuracy of the reel gear 42 can be ensured.

### Fifth Exemplary Embodiment

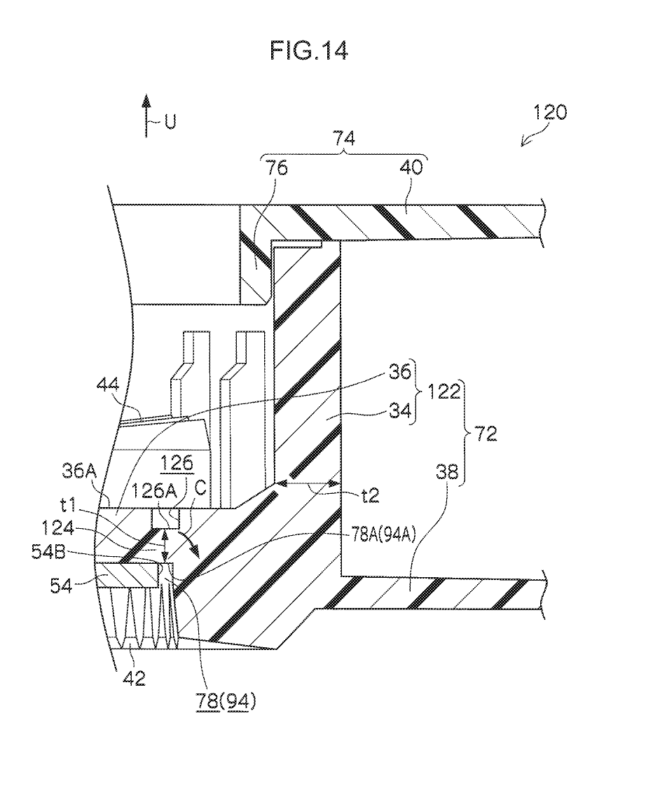

A reel 120 relating to a fifth exemplary embodiment of the present invention is shown in FIG. 14 in a side sectional view corresponding to FIG. 1. As shown in FIG. 14, a reel hub 122 structuring the reel 120 differs from the reels 10, 90 of the first and second exemplary embodiments with regard to the point that the reel hub 122 has a thin-walled portion 124 instead of the thin-walled portion 82.

The thin-walled portion 124 at the reel hub 122 is formed continuously over the entire periphery by forming an annular recess 126 in a portion of the top surface 36A of the floor portion 36, which portion overlaps the groove portion 78, 94 in the radial direction. The thickness t1 of the thin-walled portion 124 in the present exemplary embodiment is set to be the minimum thickness from a floor surface 126A of the annular recess 126 to the floor surface 78A, 94A of the groove portion 78, 94.

Namely, one end in the thickness direction of the thin-walled portion 124 is the floor surface 78A, 94A of the groove portion 78, 94. The thin-walled portion 124 in the present exemplary embodiment is formed so as to be the thinnest in the direction along the axial direction of the reel hub 32. The other structures of the reel 120 are the same as the corresponding structures of the reel 10, including the portions that are not illustrated.

Accordingly, the reel 120 relating to the fifth exemplary embodiment as well can achieve similar effects due to structures that are basically similar to those of the reels 10, 90 relating to the first and second exemplary embodiments. Further, at the reel 120, because no thin-walled portion due to the annular recess 116 or the like is formed, the flowability of the resin at the time of injection molding the lower flange attached hub member 72 is ensured. Therefore, at the reel 120, for example, a resin of a high molecular weight (around several 10,000) can be employed in order to ensure drop strength.

### Sixth Exemplary Embodiment

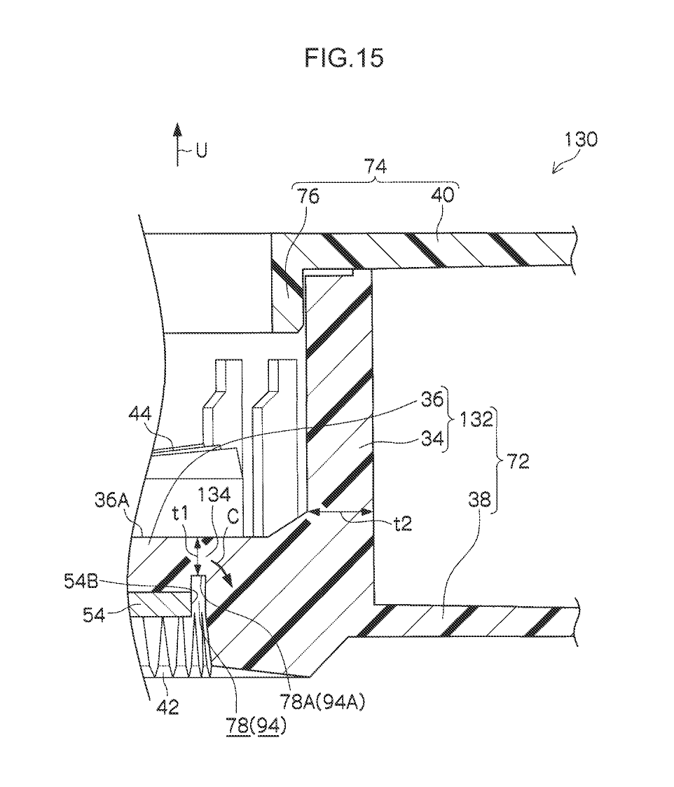

A reel 130 relating to a sixth exemplary embodiment of the present invention is shown in FIG. 15 in a side sectional view corresponding to FIG. 1. As shown in FIG. 15, a reel hub 132 structuring the reel 130 differs from the reels 10, 90 of the first and second exemplary embodiments with regard to the point that the reel hub 132 has a thin-walled portion 134 instead of the thin-walled portion 82.

The thin-walled portion 134 at the reel hub 132 is formed continuously over the entire periphery. The thickness t1 of the thin-walled portion 134 is set to be the minimum thickness from the top surface 36A of the floor portion 36 to the floor surface 78A, 94A of the groove portion 78, 94. Namely, one end in the thickness direction of the thin-walled portion 134 is the floor surface 78A, 94A of the groove portion 78, 94. Further, in the present exemplary embodiment, a recess corresponding to the annular recess 84, 106, 116, 126 is not formed in the top surface 36A of the floor portion 36, and the thickness t1 of the thin-walled portion 134 is prescribed by the depth of the groove portion 78, 94.

In the present exemplary embodiment, the depth of the groove portion 78, 94 is greater than the thickness of the reel plate 54. Due thereto, the thin-walled portion 134, that is formed without providing the annular recess 84, 106, 116, 126, is thinner-walled than the other portions of the floor portion 36. Therefore, the thin-walled portion 134 in the present exemplary embodiment is formed so as to be thinnest in the direction along the axial direction of the reel hub 32. The bending direction (the direction of arrow C) of the thin-walled portion 134 due to the winding pressure of the magnetic tape T in this case is substantially downward in the axial direction. The other structures of the reel 130 are the same as the corresponding structures of the reel 10, including the portions that are not illustrated.

Accordingly, the reel 130 relating to the sixth exemplary embodiment as well can achieve similar effects due to structures that are basically similar to those of the reels 10, 90, 120 relating to the first, second and fifth exemplary embodiments.

As described above, the structures relating to the respective exemplary embodiments can be appropriately selected in accordance with what functions are to be imparted to the reel and the recording tape cartridge, or what functions are to be prioritized. However, all of these forms exhibit the operational effects that the difference in deformation at the upper and lower sides of the reel hub 32 is small, and the shape of the reel hub 32 in the state in which the tape T is wound therearound is good.

Note that the above-described first through third and fifth exemplary embodiments describe examples in which the depth of the groove portion 78, 94 is equal to the thickness of the reel plate 54, but the present invention is not limited to the same. For example, the depth of the groove portion 78, 94 may be structured so as to be greater than the thickness of the reel plate 54. Further, although the above second and fourth exemplary embodiments describe examples in which the depth of the groove portion 78, 94 is greater than the thickness of the reel plate 54, the present invention is not limited to the same. For example, the depth of the groove portion 78, 94 may be structured to be the same as the thickness of the reel plate 54.

The above respective exemplary embodiments illustrate examples in which the thin-walled portion 82, 104, 114, 124, 134 is formed in an annular form that is continuous over the entire circumference. However, the present invention is not limited to the same. For example, the thin-walled portion 82, 104, 114, 124, 134 may be formed intermittently over the entire periphery. Namely, portions that are not continuous in the peripheral direction may be set at the thin-walled portion 82, 104, 114, 124, 134, such as the plate holding portions 80 that are positioned between the groove portions 78.

The respective exemplary embodiments illustrate examples in which the elastic modulus of the material structuring the upper flange member 74 is higher than the elastic modulus of the material structuring the lower flange attached hub member 72, 92, 102, 112, 122, 132, but the present invention is not limited to the same. For example, the elastic modulus of the material structuring the upper flange member 74 may be less than or equal to the elastic modulus of the material structuring the lower flange attached hub member 72, 92, 102, 112, 122, 132. Namely, the effect of reinforcing the opening end side of the cylindrical tube portion 34 with respect to the winding pressure of the magnetic tape T is not limited to a structure that depends on the material of the upper flange member 74. For example, the aforementioned reinforcing effect may be obtained by the dimensions and the shape or the like of the upper flange member 74.

Still further, the above-described respective exemplary embodiments illustrate examples in which the upper flange member 74 is joined to the lower flange attached hub member 72 at which the lower flange 38 is molded integrally with the reel hub 32 (i.e., illustrate a so-called two piece structure). However, the present invention is not limited to the same, and, for example, may be a structure (a so-called three piece structure) in which the upper flange member 74 and (a member including) the lower flange 38 are joined to the reel hub 32 that is formed in the shape of a cylindrical tube having a floor. As another example, a member that includes the lower flange 38 may be joined to a member at which the cylindrical tube portion 34 and the floor portion 36 (at least a portion in the thickness direction of the overhanging portion) are formed integrally.

Further, although the respective exemplary embodiments illustrate examples in which the engaging gears 44 are divided into plural parts in the peripheral direction, the present invention is not limited to the same and may be structured such that, for example, the engaging gear 44 is formed in a continuous annular form. In this modified example as well, the difference in deformation at the upper and lower sides of the reel hub 32 is small, and the shape of the reel hub 32 in a state in which the tape T is wound therearound is good. Therefore, it is confirmed that deformation of the magnetic tape T that is wound around the reel 10 is prevented or effectively suppressed. Moreover, the present invention is not limited to an example in which the engaging gears 44 are disposed so as to overlap the range, in the radial direction of the reel hub 32, at which range the groove portions 78 are formed. For example, the engaging gears 44 may be disposed at the radial direction inner side of the groove portions 78.

Although the above-described respective exemplary embodiments are structured such that the magnetic tape T is used as the recording tape, the present invention is not limited to the same. It suffices for the recording tape to be interpreted as an elongated-tape-shaped information recording/playback medium onto which information can be recorded and from which recorded information can be played-back. It goes without saying that the recording tape cartridge can be applied as well to recording tapes of any recording/playback systems.

Moreover, the respective exemplary embodiments illustrate examples in which polycarbonate containing glass fibers is used as the material structuring the reel hub 32 and the upper flange 40 (the lower flange 38), but the present invention is not limited to the same, and any of various types of materials can of course be used.

Still further, although the exemplary embodiments illustrate examples in which the reel 10 is applied to the recording tape cartridge 11, the present invention is not limited to the same. For example, the present invention can be applied to a recording tape cartridge that accommodates, within a case, two reels that are a reel for drawing-out and a reel for taking-up. In this case, it suffices for the present invention to be applied to at least one of the reels. Further, the present invention can also be applied to a take-up reel or the like of a drive device.

What is claimed is:

1. A reel comprising:
a hub that is made of resin and has a cylindrical tube portion, around whose outer peripheral surface a recording tape is wound, and an overhanging portion, that juts-out inwardly in a radial direction from one end portion side in an axial direction of the cylindrical tube portion; and
a plate that is made of metal, and that forms a disc shape or an annular shape that is coaxial with the hub, and that is fixed to the overhanging portion,
wherein a thin-walled portion, that is made to be thinner than a radial direction thickness at one end portion side of the cylindrical tube portion, is formed continuously or intermittently over an entire periphery at a portion between an inner peripheral surface of the hub and an outer peripheral surface of the plate in a radial direction of the overhanging portion.

2. The reel of claim 1, wherein a groove, at which the outer peripheral surface of the plate is at least a portion of a groove wall, is formed continuously or intermittently over the entire periphery by the overhanging portion and the plate, and the thin-walled portion is formed such that one end in a thickness direction of the thin-walled portion is a groove floor or a grove wall of the groove at the overhanging portion.

3. The reel of claim 2, wherein the thin-walled portion is structured such that a depth of the groove is set to be larger than a thickness of the plate.

4. The reel of claim 1, wherein the thin-walled portion is formed so as to be thinnest in a direction along an axial direction of the hub.

5. The reel of claim 1, wherein the thin-walled portion is formed so as to be thinnest in a direction along a radial direction of the hub.

6. The reel of claim 1, wherein a reinforcing member, that is structured of a material having a higher elastic modulus than a material structuring the hub and that reinforces the cylindrical tube portion in a radial direction, is provided at another end portion in the axial direction at the cylindrical tube portion.

7. The reel of claim 1, wherein a plurality of portions, that cover the outer peripheral surface of the plate from a radial direction outer side while contacting the outer peripheral surface, are formed at the groove portion.

8. The reel of claim 1, wherein the thin-walled portion is formed between the plate and an annular recess that is formed continuously over the entire periphery at an outermost peripheral portion of a top surface of the overhanging portion.

9. The reel of claim 8, wherein the annular recess has a shape that gradually becomes deeper toward an inner peripheral surface of the cylindrical tube portion.

10. The reel of claim 8, wherein a depth of the annular recess is substantially uniform in a radial direction.

11. The reel of claim 10, wherein the annular recess is formed at a position that is offset, in a radial direction of the reel, with respect to the groove portion.

12. The reel of claim 10, wherein the annular recess is formed at a position that overlaps the groove portion in an axial direction of the reel.

13. The reel of claim 10, wherein the annular recess is formed at a position that overlaps the groove portion in a radial direction of the reel.

14. A recording tape cartridge comprising:
the single reel of claim 1 at which the recording tape is wound around an outer periphery of the hub; and
a case that accommodates the reel such that the reel is rotatable.
